(19) United States
(12) Patent Application Publication
(10) Pub. No.: US 2016/0306036 A1
(43) Pub. Date: Oct. 20, 2016

(54) SYSTEMS AND METHODS TO TRACK A GOLF BALL TO AND ON A PUTTING GREEN

(71) Applicant: EDH US LLC, Orlando, FL (US)

(72) Inventor: Henri Johnson, Windermere, FL (US)

(21) Appl. No.: 15/101,811

(22) PCT Filed: Dec. 3, 2014
(86) PCT No.: PCT/US14/68334

§ 371 Date: Jun. 3, 2016

Related U.S. Application Data
(60) Provisional application No. 61/911,396, filed on Dec. 3, 2013.

(51) Int. Cl. G01S 13/72; H04N 13/02; G06T 7/20; G06K 9/00; G01S 13/86; G01S 13/58

(52) U.S. Cl. CPC G01S 13/72; G01S 13/867; G01S 13/86; G01S 13/58; G06T 7/2033; G06K 9/00724; H04N 13/0203; G06T 2207/10021; G06T 2207/30224; G06T 2207/30241

(57) ABSTRACT

Systems, methods and media to track a golf ball to and on a green are provided. In an example embodiment, a method comprises arranging golf ball tracking components including a 3-D tracking Doppler radar, and at least one camera adjacent the green, and connecting a processor with signal sampling capability to the tracking components. The positions and orientations of the tracking components relative to a location in the green, for example the pin hole, are entered into the processor. In one example, microphones are provided. The tracking radar detects a golf ball approaching the green and the microphones detect the landing. The processor calculates the landing position of the ball based on signals received from the radar, the microphones, or the at least one camera. The camera records images of the ball on the green and the processor processes the images of the ball to construct a composite difference image of ball positions and movement on the green, and uses the composite difference image to determine a final position of the ball on the green.

### RELATED APPLICATIONS

This application claims priority from U.S. Provisional Patent Application Ser. No. 61/911,396, filed Dec. 3, 2013, which is incorporated herein by reference in its entirety and made a part hereof.

### BACKGROUND

Spectators and players at golf tournaments are interested in the path of a golf ball approaching a green, the landing and final resting positions of the ball. The information can be displayed by means of electronic media including television, public displays, personal electronic devices, and the internet. Data can also be saved to data bases as statistical records. The present disclosure relates to tracking a golf ball trajectory as it approaches the green, as well as ball positions and path on the green after landing.

### SUMMARY

The systems and methods of the present disclosure use 3-D tracking Doppler radar to measure the Doppler speed and direction angles of a golf ball during an approach shot to a putting green on a golf course.

In broad terms, a radar is used to see a ball coming “in” to a green. This is beneficial because from any “usual” location the ball will be receding and even be lost, and measurements will be poor. A problem nevertheless remains in that the Doppler data is not referenced to an origin, which is needed to calculate a trajectory in world coordinates. The inventor proposes to solve this problem by providing the radar with at least one known point which could be, for example, the ball landing spot, or another known location. The radar can “see” the landing (or other location) and in one example calculations are based on this accordingly.

In another example, one or two cameras are used to determine the landing location. In yet another example, microphones are used. A radar device that has distance measuring ability can also be used, addressing the problem of providing an origin for real world coordinates as well. These various methods are described further below.

A useful benefit in using radar is that the radar can “see” a ball coming in advance, and can warn the cameras and/or microphones of an event. This reduces the amount of processing required (e.g. volumes of image data) and improves reliability. Further or alternatively, two cameras can be used in stereo mode which also provides “3D tracking” of the ball before landing independently of or in conjunction with the radar. The camera(s) correctly set up can also measure other ball data such as the bounce and roll (collectively “the path”) of a ball after landing until rest. The cameras can continue to measure ball actions (attempted putts) on the green. In each case, a path, final position, miss distance and relative final-to-pin/hole can be provided. Enhanced or natural televisions graphics of these actions can be provided.

Thus, the Doppler measurements from the radar are in one example referenced to world coordinates. Such a reference may be established by using a Doppler radar with distance-measuring ability. Alternately, other sensing methods may be used to determine the landing position of the ball on the green and to use this landing position as a means to relate the measurements from the Doppler radar to world coordinates. One method to determine a landing position is to use microphones arranged around the green and apply a method of acoustic trilateration. Another method to determine landing position is to use one or more cameras arranged near the green, pointed to provide a view of the surface of the green and its nearby surroundings, and to use an image-processing method to determine, amongst other measurements, the ball's landing position.

This landing position can be fed to the Doppler radar and/or an associated processor to relate the incoming flight path of the golf ball to world coordinates.

Camera images may be captured and processed to provide measurements in addition to the landing position of the ball. For example, the final ball trajectory before impact, as well as the post-impact path of the ball, up to and including its final lie position can be determined. This functionality differs from conventional methods and does not require prior knowledge of the greens.

Television cameras, including “slow motion” cameras, are currently used as sources of limited information and imagery relating to a ball's flight to a green as well as to putting strokes on the green during golf tournaments, for example. But apart from visual images, conventional coverage of golf shots around and on greens provide little quantitative data such as (but not limited to) the landing position distance from the pin, ball speeds, roll distances, lie distance to the pin, length of putts, or miss distances of putts.

AIMPOINT™ is a television graphics software system that predicts the optimum putting direction and ball path based on prior data of the slope (or break) of the green. The prediction is presented as an overlay on a television image. No data is provided of the approach shot.

The present subject matter can provide measured data of the approaching golf ball trajectory, as well as the ball positions and path on the green after landing. Such measurements are not currently derivable from television, much less made available to television or for use in other applications. Thus, the methods and systems described herein can also be used to create a system or a data service for television broadcast enhancement, and in some examples provide a data service for personal mobile devices. In some examples, a repository of statistical technical data of golf tournaments can be built up and stored in a database, and used to provide a data service for sponsored information displays.

In this specification, the term “golf ball” is used but this is intended to cover any projectile that can be tracked in the air or on a “target region of interest”, such as a putting green.

Thus, in some embodiments, a method of tracking a golf ball to and on a putting green (target region of interest) comprises arranging golf ball tracking components operationally in relation to a target region of interest, the components including a 3-D tracking Doppler radar, and at least one camera; connecting a processor with signal sampling capability to the tracking components; calibrating the at least one camera to world or reference coordinates; entering, into the processor, in world or reference coordinates, the positions and orientations of the tracking components relative to a location in the target region of interest; using the Doppler radar to detect a golf ball approaching the target region of interest; using the at least one camera to record images of the ball within the target region of interest; processing the images of the ball to construct a composite difference images of ball positions and movement in the target region of interest; and analyzing the composite difference images to determine a landing position and a final position of the ball in the target region of interest.

The tracking components further comprise at least one microphone, and the method may further comprise using the at least one microphone to detect a landing of the approaching ball in the target region of interest; and using the radar to measure a speed and a direction of the approaching ball.

The landing position of the ball may be calculated by the processor using a sound delay time or a triangulation algorithm based on signals received from the Doppler radar, the at least one camera, or the at least one microphone. The method may further comprise using the composite difference images to determine a path of the ball before landing, and in between the landing and final positions of the ball. Still further, the method may comprise outputting data relating to the landing position, the final position, the path of the ball before landing, and the path of the ball between landing and final positions to an external system.

The method may further comprise calculating a 3-D trajectory of the approaching ball from the measured ball speed and directional ball position data, and outputting data relating to the 3-D trajectory to an external system.

In another example embodiment, a system for tracking a golf ball to and in a region of interest, the system comprises golf ball tracking components including a 3-D tracking Doppler radar, and at least one camera; the processor including signal sampling capability and being configured to receive data relating to the positions and orientations of the tracking components relative to a location in the target region of interest; the radar being configured to detect a golf ball approaching the target region of interest; the camera being configured to record images of the ball within the target region of interest; the processor further configured to process the images of the ball to construct a composite difference image of ball positions and movement in the target region of interest, and use the composite difference image to determine a final position of the ball in the target region of interest from the composite difference image data.

In another embodiment, a non-transitory machine-readable medium containing instructions that, when read by a machine, cause the machine to perform operations comprising receiving, in real world or reference coordinates, positions and orientations of golf ball tracking components relative to a location in a target region of interest, the golf ball tracking components including a 3-D tracking Doppler radar, and at least one camera; receiving data from the radar relating to a detected golf ball approaching the target region of interest; receiving, from the camera, data relating to recorded images of the ball within the target region of interest; processing the recorded images of the ball to construct a composite difference image of ball positions and movement in the target region of interest; and use the composite difference image to determine a final position of the ball in the target region of interest.

In another example, a further method of tracking a golf ball to and on a target region of interest is provided. The method comprises detecting, using radar having a coordinate system, the presence of an approaching golf ball aimed towards the target region based on a measured speed and direction angle with signal levels checked against predetermined threshold levels; detecting, using a microphone array including at least three microphones, a landing impact of the golf ball by comparing signals received from the microphones against signal level threshold values; locating the impact position by calculating the time of arrival difference of the impact sound at each of the at least three microphones in the array, and using a triangulation algorithm to calculate the origin of the sound; calculating the trajectory of the approaching golf ball using an algorithm of backwards numerical integration of the radar-measured speed and directional angle, and using the ball impact position as reference for the numerical integration; transforming ball trajectory data from the radar coordinate system to real world coordinates, using algorithms to perform coordinate axis translation and rotation; and outputting impact position and trajectory data to an external system.

The method may further comprise calculating an impact speed and impact angle of the ball relative to the target of interest from the approach trajectory and, still further, may comprise using a camera and processor to construct difference images from successive collections of images of the ball, and combining sequences of difference images to create a combined image of ball positions in the target region of interest.

The method may further comprise performing intensity and threshold checks to determine the presence of the ball on the target region of interest, respective locations of initial and final ball positions in the region of interest, and a trajectory of the ball in between these positions, in image coordinates.

The method may further comprise calculating the respective locations of the of initial and final ball positions and trajectory in real world coordinates based on corresponding data in image coordinates and pre-identified camera position, orientation and field of view data. Still further, the method may further comprise calculating at least one of a distance to hole, path curvature, initial direction, and hole miss distance based on the locations of the initial and final ball positions and trajectory in between these positions.

In another example method of tracking a golf ball to and on a putting green, method operations may comprise arranging golf ball tracking components operationally in relation to a target region of interest, the components including a 3-D tracking Doppler radar, and a plurality of microphones; connecting a processor with signal sampling capability to the tracking components; entering, into the processor, in world or reference coordinates, the positions and orientations of the tracking components relative to a location in the target region of interest; using the Doppler radar to detect a golf ball approaching the target region of interest; using the microphones to detect a landing of the approaching ball in the target region of interest; and using the processor to calculate the landing position of the ball based on signals received from the microphones.

In another example embodiment, a system comprises golf ball tracking components including a 3-D tracking Doppler radar, and plurality of microphones; the processor including signal sampling capability and being configured to receive data relating to the positions and orientations of the tracking components relative to a location in the target region of interest; the Doppler radar being configured to detect a golf ball approaching the target region of interest; the microphones being configured to detect a landing of the approaching ball in the target region of interest; the processor being further configured to calculate the landing position of the ball based on signals received from the microphones.

In yet another example, a method of tracking a golf ball to and on a target region of interest comprises detecting, using radar having a coordinate system, the presence of an approaching golf ball aimed towards the target region based on a measured speed and direction angle with signal levels checked against predetermined threshold levels; processing images from one or more cameras to produce composite difference images using stereoscopic principles; locating a landing position of the ball in the region of interest from the processed images in image coordinates; calculating a trajectory of the approaching golf ball using an algorithm of backwards numerical integration of the radar-measured speed and directional angle, and using the ball landing position as reference for the numerical integration; transforming ball trajectory data from the radar coordinate system to real world coordinates, using algorithms to perform coordinate axis translation and rotation; and outputting landing position and trajectory data to an external system.

The method may further comprise calculating an impact speed and impact angle of the ball relative to the target of interest from the approach trajectory. The method may further comprise using the one or more cameras and the processor to construct difference images from successive collections of images of the ball, and combining sequences of difference images to create a combined image of ball positions in the target region of interest. Still further, the method may comprise performing intensity and threshold checks to determine the presence of the ball on the target region of interest, respective locations of initial and final ball positions in the region of interest, and a trajectory of the ball in between these positions, in image coordinates. The method may further comprise calculating the respective locations of the of initial and final ball positions and trajectory in real world coordinates based on corresponding data in image coordinates and pre-identified camera position, orientation and field of view data. The method may still further comprise calculating at least one of a distance to hole, path curvature, initial direction, and hole miss distance based on the locations of the initial and final ball positions and trajectory in between these positions.

These and other examples and features of the present disclosure will be set forth in part in the following Detailed Description. This Summary is intended to provide non-limiting examples of the present subject matter—it is not intended to provide an exclusive or exhaustive explanation. The Detailed Description below is included to provide further information about the present systems, methods and machine-readable media.

### DESCRIPTION OF THE DRAWINGS

The example embodiments may be better understood, and its numerous features and advantages made apparent to those skilled in the art by referencing the accompanying drawings and descriptions provided in the Detailed Description. For ease of understanding and simplicity, common numbering of elements within the illustrations is employed where an element is the same in different drawings. In the drawings, which are not necessarily drawn to scale, like numerals may describe similar components in different views. In some instances, different numerals may describe similar components in different views. Like numerals having different letter suffixes may represent different instances of similar components. The drawings illustrate generally, by way of example, but not by way of limitation, various embodiments discussed in the present document.

FIG. 1 is a schematic view of components of a system to track a golf ball to and on a putting green, according to example embodiments.

FIG. 2 is a flow diagram of operations of a method, according to an example embodiment.

FIG. 3 is a schematic view of a putting green with some components of the present system located adjacent the green, according to example embodiments.

FIG. 4 is a further schematic view showing aspects of the current system and methods, according to example embodiments.

FIG. 5 is a further schematic view showing further aspects of the current system and methods, according to example embodiments.

FIG. 6 is a further schematic view showing further aspects of the current system and methods, according to example embodiments.

FIG. 7 is a block diagram of a machine in the example form of a computer system within which a set of instructions may be executed for causing the machine to perform any one or more of the methodologies herein discussed.

### DETAILED DESCRIPTION

The following is a detailed description of illustrative embodiments of the present invention. As these embodiments of the present invention are described with reference to the aforementioned drawings, various modifications or adaptations of the methods and or specific structures described may become apparent to those skilled in the art. All such modifications, adaptations, or variations that rely upon the teachings of the present inventions, and through which these teachings have advanced the art, are considered to be within the spirit and scope of the present invention. Hence, these descriptions and drawings are not to be considered in a limiting sense, as it is understood that the present invention is in no way limited to the embodiments illustrated.

Viewed broadly, the present invention includes the following features and method steps. A 3-D tracking Doppler radar capable of measuring the radial speed directional angles of an approaching golf shot is provided adjacent a green. A plurality of microphones (ideally three or more) and a digital camera (or two) are set up in vantage positions near the green. A processor with suitable software and signal sampling apparatus is connected to these components. The radar, camera, and microphones are set up in combination at suitable positions and orientations near the putting green on a golf hole. The positions and orientations of the equipment relative to the green and hole in real world coordinates are entered into the processor. The radar detects an approach shot and measures the approaching speed and directional angles. The audio signals are sensed to detect a landing ball. The landing position is calculated using sound delay times and triangulation.

Camera images of the green are recorded and image processing is performed to construct a composite difference image of the ball positions and movement. The landing position, final position, the ball path in between, and other data of the ball trajectory on the green are determined from the composite difference image. The ball positions and trajectory from the camera images are output to external systems. The 3-D trajectory of the approaching ball is calculated from the ball speed and directional position data and the approach trajectory data is also output to external systems. After the system components are initially set up as described above, the subsequent steps (radar detection and so forth) are repeated indefinitely (or as long as needed) for approach shots and/or putts played to and on the green.

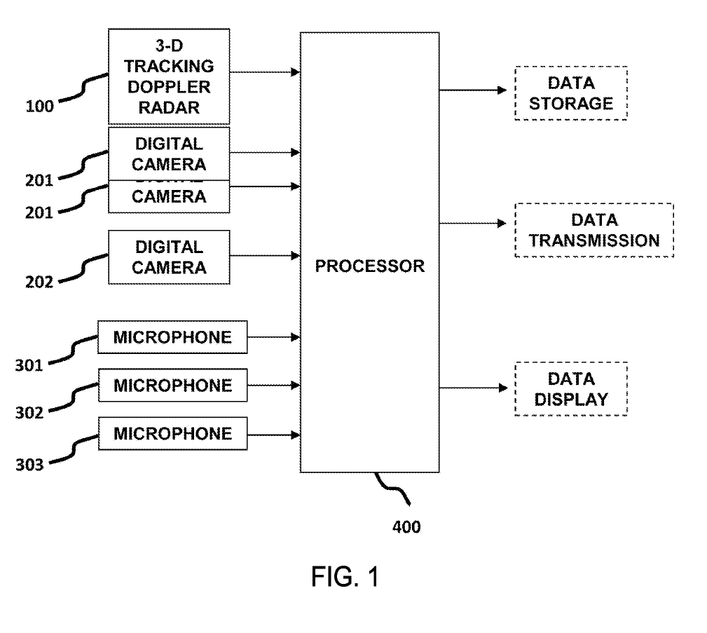

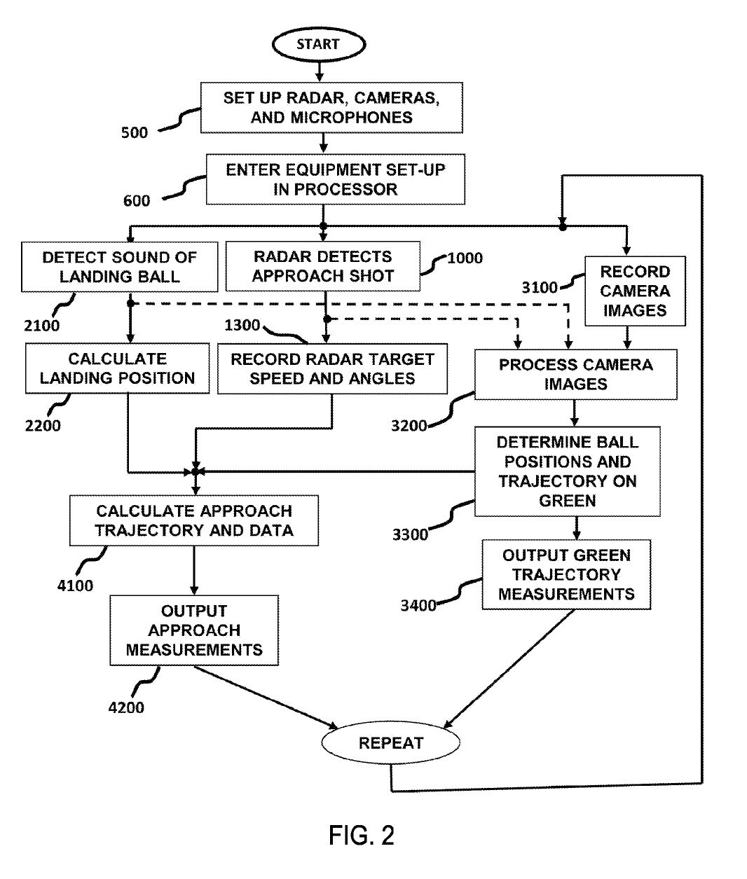

Thus with reference now to FIG. 1, elements of the golf ball tracking system include a 3-D tracking Doppler radar 100, a set of digital cameras 201 and 202, a set of microphones 301-303, and a processor 400 programmed with suitable software. A preferred relationship between the elements is shown in FIG. 1, but other configurations are possible. An example sequential flow of the associated method steps, numbered accordingly and using these elements of FIG. 1, is shown in FIG. 2. These steps are discussed further below.

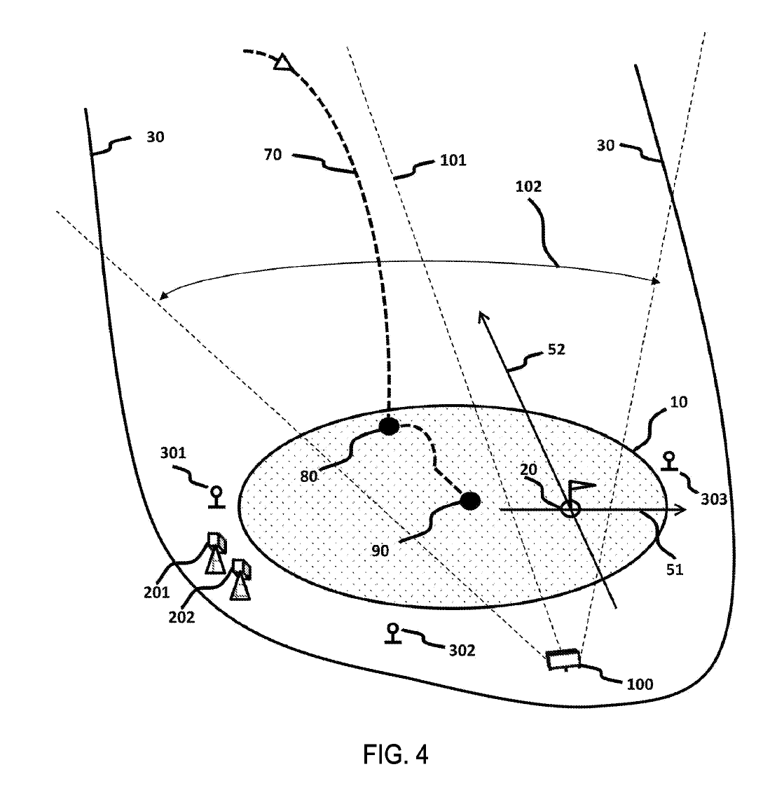

For simplicity some of the descriptions herein relate to the minimum equipment required. Measurements and calculations of positions are described in two dimensions, with the coordinate framework being a horizontal plane with X-axis 51 and Y-axis 52 being an arbitrary choice, for example as shown in FIG. 4. The method can however be extended to multiples of cameras, microphones and radars and to three-dimensional geometry.

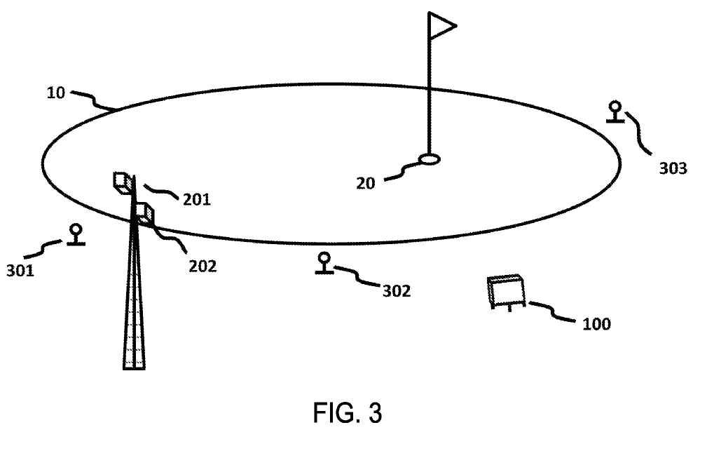

With reference now to FIG. 3, the process starts by setting up cameras 201-202, microphones 301-303, and a Doppler radar 100 to cover the green 10 and the approach to the green at a hole 20. The cameras 201-202, microphones 301-303 and radar positions, directions and field of view relative to the chosen coordinates characteristics are recorded and entered in a processor (400 in FIG. 1).

With reference now to FIG. 4, the radar 100 is located near the green 10, with its pointing (or reference) axis 101 and field of view 102 pointed along a fairway 30 to enable the radar 100 to sense an approaching golf shot 70. The measured radial velocity, elevation and azimuth angles of the approaching golf ball are sent to the processor 400 for processing.

The cameras 201-202 send digital images of the green 10 to the processor 400 for image processing. The processor 400 outputs processed ball data to external systems for storage, transmission, or display.

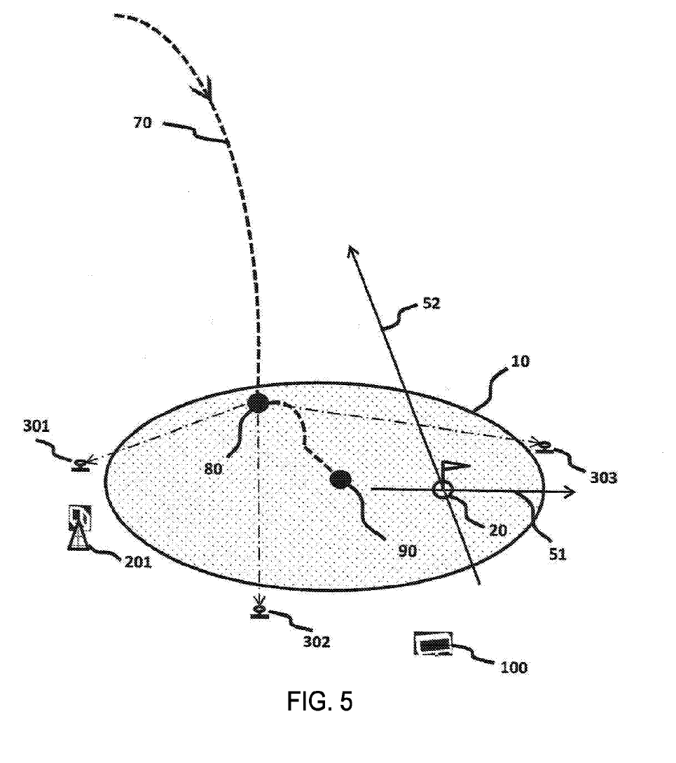

The microphones 301-303 are set up near the green 10 to pick up the impact sound of the landing golf ball at position 80—also shown in FIG. 5. The impact signals are sent to the processor 400 where they are processed with the Doppler measurements from the radar 100.

With reference to FIG. 5, the Doppler radar 100 detects and tracks an approaching golf shot 70, and records the radial Doppler velocity and relative elevation and azimuth angles of the ball during flight.

The sound signals from the microphones 301-303 are supplied to the processor 400. The processor 400 determines the time of arrival difference for every microphone pair. The processing may include threshold comparison and cross-correlation. The processor 400 uses the time of arrival differences in a trilateration method to calculate the landing position 80 being the sound source.

The landing position 80 is used by the processor 400 as a point of origin to calculate the ball trajectory 70. The calculation uses numerical integration of the measured ball speed data and the landing position is used as the reference position for the calculation.

The camera 201 takes sequences of images of the green 10 and sends these to the processor 400. The processor may be guided by the detection of an incoming ball from the Doppler radar 100, detection of the ball landing by the microphones, or may otherwise process the images continuously. The processing step includes image differencing and threshold detection in the difference images, and if more than one camera is employed, to use stereoscopic principles. The landing position 51 and final position 52 of the ball can be determined from this.

The cameras may be set up to take sequential stereoscopic images. The images from multiple cameras can be combined by using stereoscopic principles to determine the ball's trajectory in three dimensions in world coordinates.

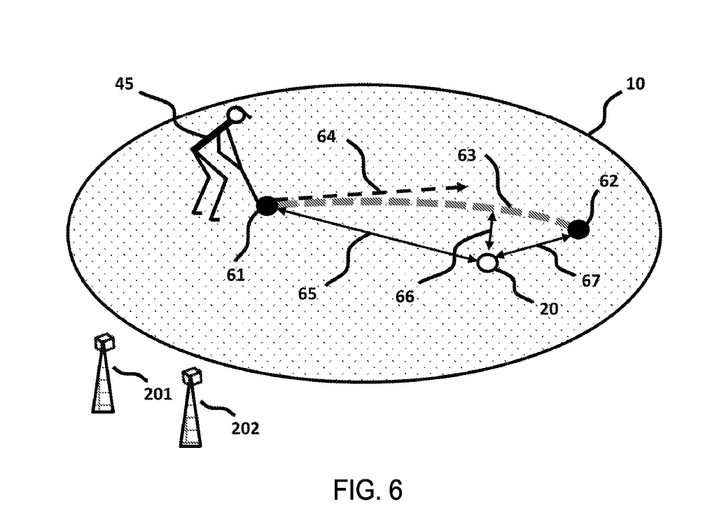

With reference to FIG. 6, if a golfer 45 performs a further putting stroke on the green 10, camera images are sent to the processor 400 to determine the initial position 61, final position 62, ball trajectory 63, miss distance 66, initial hole distance 65, initial direction 64 and path curvature (in golf terms: break) and final hole distance 67. All this data can be stored, transmitted, or displayed on external systems.

Some embodiments of the present inventive subject matter include methods of tracking a golf ball to and on a putting green. These method embodiments are also referred to herein as “examples” and are summarized further above. Such examples can include method elements in addition to those shown or described. However, the present inventor also contemplates examples in which only those method elements shown or described are provided. Moreover, the present inventors also contemplate examples using any combination or permutation of those method elements shown or described above (or one or more aspects thereof), either with respect to a particular example (or one or more aspects thereof), or with respect to other examples (or one or more aspects thereof) shown or described herein.

The measurement of the positions and trajectory of a ball moving on the surface of the green can be done at either of two occasions: when a ball lands on the green, and at any other time when a golfer plays a putting shot. If only the approach shot trajectory and landing position is of interest, the measurement of the ball on the green by means of camera images can be left out. If only the movement of the ball on the green is required, the radar and microphone measurement of the approaching and landing ball can be left out.

As an alternative to processing the camera images continuously and autonomously, the processor 400 may be guided, gated or triggered by the detection of an approaching ball by the radar 100. Alternatively, the processor 400 may be guided, gated or triggered by the detection of an acoustic impact sound from the microphones 301-303. In both the above alternatives, the processor 400 may store a sufficient number of camera images in a memory buffer to cater for any time delay of ball detection from either the radar or microphone sensors.

With reference again to FIG. 3, some optional or preferred system enhancements are now discussed. As described above, before operation, the camera 100, 3-D Doppler radar 200, and microphones 301-303 are set up at the green 10 of a golf course hole 20. The camera 100 is positioned at a height and with a pointing direction to cover the green 10 by its field of view. At least three microphones 301-303 are arranged around the green 10 in a way that will favor picking up sounds from the green. The microphones 301-303 may be fitted with wind noise baffles and may have directional characteristics.

The processor 400 (FIG. 1) is connected to the camera 100, radar 200, and microphones 301-303. The processor 400 is also connected to any or all of the following: systems for data storage, transmission, or display. The processor 400 receives the Radar tracking data, microphone signals, and camera images. It processes the signals, data and images according to the steps discussed above and illustrated as examples in FIG. 2. The processor 400 outputs the results as data to connected storage, transmission or display systems for further use. The described systems and methods can produce or be part of a system or a data service for television broadcast enhancement. They can also provide a data service for personal mobile devices and create a repository of statistical technical data for golf tournaments. In some instances, a data service can be provided for sponsored information displays.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures usually require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

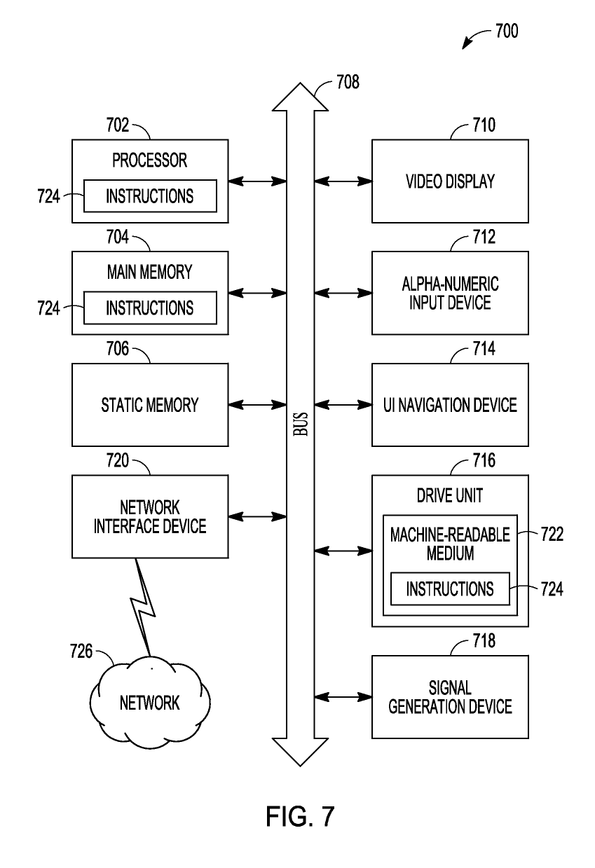

FIG. 7 is a block diagram of machine in the example form of a computer system 800 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation or cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, with the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more data structures or instructions 724. The term “machine-readable medium” shall also be taken to include any tangible medium that is capable of storing, encoding, or carrying instructions for execution by the machine and that cause the machine to perform any one or more of the methodologies of the embodiments of the present invention, or that is capable of storing, encoding or carrying data structures utilized by or associated with such instructions. The term “machine-readable medium” shall accordingly be taken to include, but not be limited to, solid-state memories and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 724 may further be transmitted or received over a communications network 326 using a transmission medium. The instructions 724 may be transmitted using the network interface device 720 and any one of a number of well-known transfer protocols (e.g., HTTP). Examples of communication networks include a LAN, a WAN, the Internet, mobile telephone networks, Plain Old Telephone (POTS) networks, and wireless data networks (e.g., Wi-Fi™ and WiMax™ networks). The term “transmission medium” shall be taken to include any intangible medium that is capable of storing, encoding or carrying instructions for execution by the machine, and includes digital or analog communications signals or other intangible media to facilitate communication of such software.

While the invention has been described with reference to specific embodiments, it will be understood by those skilled in the art that various changes may be made and equivalents may be substituted for the elements thereof without departing from the true spirit and scope of the invention. In addition, modifications may be made without departing from the essential teachings of the invention. Moreover, each of the non-limiting examples described herein can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method comprising:
arranging golf ball tracking components operationally in relation to a target region of interest, the components including a 3-D tracking Doppler radar, and at least one camera;
connecting a processor with signal sampling capability to the tracking components;
calibrating the at least one camera to world or reference coordinates;
entering, into the processor, in world or reference coordinates, the positions and orientations of the tracking components relative to a location in the target region of interest;
using the Doppler radar to detect a golf ball approaching the target region of interest;
using the at least one camera to record images of the ball within the target region of interest;
processing the images of the ball to construct a composite difference images of ball positions and movement in the target region of interest; and
analyzing the composite difference images to determine a landing position and a final position of the ball in the target region of interest.

2. The method of claim 1, wherein the tracking components further comprise at least one microphone, and wherein the method further comprises:
using the at least one microphone to detect a landing of the approaching ball in the target region of interest; and
using the radar to measure a speed and a direction of the approaching ball.

3. The method of claim 2, wherein the landing position of the ball is calculated by the processor using a sound delay time or a triangulation algorithm based on signals received from the Doppler radar, the at least one camera, or the at least one microphone.

4. The method of claim 1, further comprising:
using the composite difference images to determine a path of the ball before landing, and in between the landing and final positions of the ball.

5. The method of claim 4, further comprising:
outputting data relating to the landing position, the final position, the path of the ball before landing, and the path of the ball between landing and final positions to an external system.

6. The method of claim 2, further comprising;
calculating a 3-D trajectory of the approaching ball from the measured ball speed and directional ball position data, and
outputting data relating to the 3-D trajectory to an external system.

7. A system for tracking a golf ball to and in a region of interest, the system comprising:
golf ball tracking components including a 3-D tracking Doppler radar, and at least one camera;
the processor including signal sampling capability and being configured to receive data relating to the positions and orientations of the tracking components relative to a location in the target region of interest;
the radar being configured to detect a golf ball approaching the target region of interest;
the camera being configured to record images of the ball within the target region of interest;
the processor further configured to
process the images of the ball to construct a composite difference image of ball positions and movement in the target region of interest, and
use the composite difference image to determine a final position of the ball in the target region of interest from the composite difference image data.

8. A non-transitory machine-readable medium containing instructions that, when read by a machine, cause the machine to perform operations comprising:
receiving, in real world or reference coordinates, positions and orientations of golf ball tracking components relative to a location in a target region of interest, the golf ball tracking components including a 3-D tracking Doppler radar, and at least one camera;
receiving data from the radar relating to a detected golf ball approaching the target region of interest;
receiving, from the camera, data relating to recorded images of the ball within the target region of interest;
processing the recorded images of the ball to construct a composite difference image of ball positions and movement in the target region of interest; and
use the composite difference image to determine a final position of the ball in the target region of interest.

9. A method of tracking a golf ball to and on a target region of interest, the method comprising:
detecting, using radar having a coordinate system, the presence of an approaching golf ball aimed towards the target region based on a measured speed and direction angle with signal levels checked against predetermined threshold levels;
detecting, using a microphone array including at least three microphones, a landing impact of the golf ball by comparing signals received from the microphones against signal level threshold values;
locating the impact position by calculating the time of arrival difference of the impact sound at each of the at least three microphones in the array, and using a triangulation algorithm to calculate the origin of the sound;
calculating the trajectory of the approaching golf ball using an algorithm of backwards numerical integration of the radar-measured speed and directional angle, and using the ball impact position as reference for the numerical integration;
transforming ball trajectory data from the radar coordinate system to real world coordinates, using algorithms to perform coordinate axis translation and rotation; and
outputting impact position and trajectory data to an external system.

10. The method of claim 9, further comprising:
calculating an impact speed and impact angle of the ball relative to the target of interest from the approach trajectory.

11. The method of claim 9, further comprising:
using a camera and processor to construct difference images from successive collections of images of the ball, and combining sequences of difference images to create a combined image of ball positions in the target region of interest.

12. The method of claim 11, further comprising:
performing intensity and threshold checks to determine:
the presence of the ball on the target region of interest,
respective locations of initial and final ball positions in the region of interest, and
a trajectory of the ball in between these positions,
in image coordinates.

13. The method of claim 12, further comprising calculating the respective locations of the of initial and final ball positions and trajectory in real world coordinates based on corresponding data in image coordinates and pre-identified camera position, orientation and field of view data.

14. The method of claim 13, further comprising calculating at least one of a distance to hole, path curvature, initial direction, and hole miss distance based on the locations of the initial and final ball positions and trajectory in between these positions.

15. A method comprising:
arranging golf ball tracking components operationally in relation to a target region of interest, the components including a 3-D tracking Doppler radar, and a plurality of microphones;
connecting a processor with signal sampling capability to the tracking components;
entering, into the processor, in world or reference coordinates, the positions and orientations of the tracking components relative to a location in the target region of interest;
using the Doppler radar to detect a golf ball approaching the target region of interest;
using the microphones to detect a landing of the approaching ball in the target region of interest; and
using the processor to calculate the landing position of the ball based on signals received from the microphones.

16. A system for tracking a golf ball to and in a region of interest, the system comprising:
golf ball tracking components including a 3-D tracking Doppler radar, and plurality of microphones;
the processor including signal sampling capability and being configured to receive data relating to the positions and orientations of the tracking components relative to a location in the target region of interest;
the Doppler radar being configured to detect a golf ball approaching the target region of interest;
the microphones being configured to detect a landing of the approaching ball in the target region of interest;
the processor being further configured to calculate the landing position of the ball based on signals received from the microphones.

17. A method of tracking a golf ball to and on a target region of interest, the method comprising:
detecting, using radar having a coordinate system, the presence of an approaching golf ball aimed towards the target region based on a measured speed and direction angle with signal levels checked against predetermined threshold levels;
processing images from one or more cameras to produce composite difference images using stereoscopic principles;
locating a landing position of the ball in the region of interest from the processed images in image coordinates;
calculating a trajectory of the approaching golf ball using an algorithm of backwards numerical integration of the radar-measured speed and directional angle, and using the ball landing position as reference for the numerical integration;
transforming ball trajectory data from the radar coordinate system to real world coordinates, using algorithms to perform coordinate axis translation and rotation; and
outputting landing position and trajectory data to an external system.

18. The method of claim 17, further comprising:
calculating an impact speed and impact angle of the ball relative to the target of interest from the approach trajectory.

19. The method of claim 17, further comprising:
using the one or more cameras and the processor to construct difference images from successive collections of images of the ball, and combining sequences of difference images to create a combined image of ball positions in the target region of interest.

20. The method of claim 17, further comprising:
performing intensity and threshold checks to determine:
the presence of the ball on the target region of interest,
respective locations of initial and final ball positions in the region of interest, and
a trajectory of the ball in between these positions,
in image coordinates.

21. The method of claim 20, further comprising calculating the respective locations of the of initial and final ball positions and trajectory in real world coordinates based on corresponding data in image coordinates and pre-identified camera position, orientation and field of view data.

22. The method of claim 21, further comprising calculating at least one of a distance to hole, path curvature, initial direction, and hole miss distance based on the locations of the initial and final ball positions and trajectory in between these positions.
